(19) United States
(12) Patent Application Publication
(10) Pub. No.: US 2007/0286525 A1
(43) Pub. Date: Dec. 13, 2007

(54) Generation of imaging filters based on image analysis

(75) Inventors: Prakash Mahesh, Schaumburg, IL (US); Murali Kumaran, Hoffman Estate, IL (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/449,085

(22) Filed: Jun. 8, 2006

(51) Int. Cl. G06K 9/36; G06K 9/00

(52) U.S. Cl. 382/276; 382/128

(57) ABSTRACT

Certain embodiments of the present invention provide a system, method and computer instructions for manipulating an image used in a medical examination. For example, in an embodiment, an image manipulation system used in a medical examination comprises: an input module configured to input an image and image information, and an analysis module configured to select an image manipulating function based on the image information. For example, in an embodiment, image information includes an imaging procedure and a body part that is the focus of the imaging procedure, and the image manipulating function is a lookup table. For example, in an embodiment, image information includes information regarding an input image and information regarding manipulation of a previously examined image, and the selected image manipulating function corresponds to an image manipulating function that was applied to the previously examined image.

### BACKGROUND OF THE INVENTION

The present invention generally relates to systems, methods and computer instructions for manipulating an image(s) used during a medical examination. More particularly, the present invention relates to systems, methods and computer instructions for selecting an image manipulating function(s).

Imaging systems are used to aid in the monitoring and/or diagnosis of ailments. Some examples of imaging techniques utilized by imaging systems are Computed Tomography (CT) imaging, Magnetic Resonance (MR) imaging, Computed Radiography (CR) imaging and/or Nuclear Medicine (NM) imaging. The images collected using an imaging system are referred to collectively as an imaging study. Once an imaging study is completed, the images therein can be displayed on a workstation, such as a Picture Arching and Communicating System (PACS) workstation, for example.

In order to learn as much as possible from an imaging study, the images therein can be manipulated. For example, if it is desirable to focus on a certain portion of an image, that image can be cropped so that only the certain portion of the image is available. In another example, if it is desirable to have a closer look at an image, that image can be enlarged. In another example, if it is desirable to focus on a certain portion of an image and have a closer look at that portion of the image, the image can be cropped and enlarged so that only the certain portion of the image is available and is enlarged. In another example, if it is desirable to adjust the brightness/contrast of an image, different window/levels can be selected. In another example, if it is desirable to improve an image by varying color and/or contrast, certain lookup tables (LUT's) can be applied to the image. In another example, if it is desirable to manipulate an image, a filter can be applied to the image to have a desired affect on the image.

Currently, in order to manipulate an image as described above, a user of a workstation, such as a PACS workstation, for example, is required to manually select which image manipulating function(s) to apply. For example, a user that desires to crop an image is required to select the crop function and the portion of the image that should be retained. In another example, in order to enlarge an image, a user is required to select the enlarge function and the amount the image is to be enlarged. In another example, in order to adjust the brightness/contrast of an image, a user is required to select the desired window/level. In another example, in order to improve an image by varying color and/or contrast, a user is required to select a desired LUT(s) to be applied to the image. In another example, in order to manipulate an image using any other filter, a user is required to select the desired filter.

Knowing in which manner to manipulate an image to provide enhanced viewing can be a challenge. That is, knowing which image manipulating function(s) to apply to an image to provide enhanced viewing can be a challenge. For example, a workstation can have numerous enlargement options, window/level settings, LUT's and filters, and an image can be cropped such that any portion of the image is retained and the rest of the image is discarded. Not only are there many choices of image manipulating functions, there are also many choices of combinations of image manipulating functions. Thus, figuring out which image manipulating function(s) to apply to an image to provide enhanced viewing can be tedious and time consuming. Further, even if a user of a workstation knows which image manipulating function(s) the user would like to apply to an image, that image manipulating function(s) may be buried in a long list of available image manipulating functions. Thus, even when it is known which image manipulating function(s) to apply to an image to provide enhanced viewing, finding the image manipulating function(s) can be tedious and time consuming. Either way, a user of a workstation spends time manipulating an image that could be spent analyzing the image.

There are systems that incorporate what is known as Computer Aided Diagnosis (CAD), which can aid in the identification of areas of interest in an image and mark such areas so that a user that is reviewing the image is alerted to the area. However, systems that incorporate CAD do not currently select image manipulating functions, such as those discussed herein, to provide enhanced viewing. Thus, a user of a system that incorporates CAD is still tasked with figuring out which image manipulating function(s) to apply to an image to provide enhanced viewing and locating the selected image manipulating function(s), both of which, as described above, can be tedious and time consuming.

Thus, there is a need for a system, method and computer instructions for selecting an image manipulating function(s).

### BRIEF SUMMARY OF THE INVENTION

Certain embodiments of the present invention provide a system, method and computer instructions for manipulating an image used in a medical examination. For example, in an embodiment, an image manipulation system used in a medical examination comprises: an input module configured to input an image and image information; and an analysis module configured to select an image manipulating function based on the image information. For example, in an embodiment, image information includes an imaging procedure and a body part that is the focus of the imaging procedure, and the image manipulating function is a lookup table. For example, in an embodiment, image information includes a histogram of the input image and the selected image manipulating function is a window level. For example, in an embodiment, image information includes information regarding an input image and information regarding manipulation of a previously examined image, and the selected image manipulating function corresponds to an image manipulating function that was applied to the previously examined image.

For example, in an embodiment, a method for manipulating an image used in a medical examination comprises: inputting an image and image information; and selecting an image manipulating function based on the image information. For example, in an embodiment, image information includes an imaging procedure and a body part that is the focus of the imaging procedure, and the image manipulating function is a lookup table. For example, in an embodiment, image information includes a histogram of the input image and the selected image manipulating function is a window level. For example, in an embodiment, image information includes information regarding an input image and information regarding manipulation of a previously examined image, and the selected image manipulating function corresponds to an image manipulating function that was applied to the previously examined image.

For example, in an embodiment, a computer-readable storage medium includes a set of computer instructions for manipulating images used in a medical examination, and the set of instructions includes: an input routine that allows an image and image information to be input; and an analysis routine that allows an image manipulating function to be selected based on the image information. For example, in an embodiment, image information includes an imaging procedure and a body part that is the focus of the imaging procedure, and the selected image manipulating function is a lookup table. For example, in an embodiment, image information includes a histogram of the input image and the image manipulating function is a window level. For example, in an embodiment, image information includes information regarding an input image and information regarding manipulation of a previously examined image, and the selected image manipulating function corresponds to an image manipulating function that was applied to the previously examined image.

### BRIEF DESCRIPTION OF THE DRAWINGS

FIG. 1 illustrates an image manipulation system used in accordance with an embodiment of the present invention.

FIG. 2 illustrates a method for manipulating an image used in accordance with an embodiment of the present invention.

FIG. 3 illustrates a set of computer instructions for manipulating an image used in accordance with an embodiment of the present invention.

The foregoing summary, as well as the following detailed description of embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

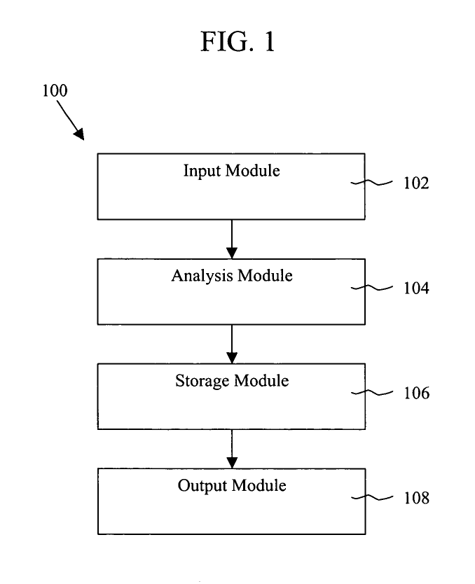

FIG. 1 illustrates an image manipulation system 100 used in accordance with an embodiment of the present invention. The system 100 in FIG. 1 includes an input module 102, an analysis module 104, a storage module 106 and an output module 108.

In the system 100, the input module 102 is configured to allow images to be input. The input module 102 can be configured to allow images to be input in many ways. For example, in certain embodiments, the input module 102 can be configured to allow images to be input from imaging systems, such as imaging scanners and/or imaging modalities, that utilize Computed Tomography (CT) imaging, Magnetic Resonance (MR) imaging, Computed Radiography (CR) imaging and/or Nuclear Medicine (NM) imaging.

In the system 100, the input module 102 is configured to allow image information to be input. The input module 102 can be configured to allow image information to be input in many ways. For example, in certain embodiments, the input module 102 can be configured to allow image information to be input from: an imaging system; a database that is part of a Radiologist Information System (RIS); a database that is part of a Hospital Information System (HIS); a database that is accessible via the Internet; a local database; and/or any information source that is in networked communication with the input module 102. Other ways to configure the input module 102 to allow image information to be input may exist, as known to those skilled in the art.

In the system 100, the input module 102 can be configured to allow different types of image information to be input. For example, in certain embodiments, the input module 102 can be configured to allow information regarding an image that is input into the input module 102 to be input and information regarding a previously analyzed image(s) to be input. For example, information regarding an image that is input into the input module 102 can include: imaging study information, such as, what type of imaging study the image is a part of, what type of ailment the imaging study is devised to detect and/or what area of the body the imaging study is focused on; patient information, such as, the patient's identity, the patient's age, the patient's sex, whether the patient has previously undergone the same and/or a similar imaging study, and/or -the patient's symptoms/signs; and/or specialist information (for example, radiologist information), such as, the specialist's identity. For example, information regarding a previously analyzed image(s) can include the same and/or similar information as that discussed in the previous sentence with regard to an image that is input into the input module 102, as well as image manipulation information, such as, what portion of the image, if any, was focused on by cropping the image, the amount the image was enlarged, if any, what window/level was associated with the image, if any, what lookup table(s) (LUT) was applied to the image, if any, and/or what filter(s) was applied to the image, if any. Other ways to configure the input module 102 to allow other types of image information to be input may exist, as known to those skilled in the art.

In the system 100, the input module 102 can be configured to allow information regarding any number of previously analyzed images to be input. For example, in certain embodiments, the input module 102 can be configured to allow information regarding any number of images that were previously analyzed in connection with: a previous examination of the same patient; a previous examination performed by the same specialist; a previous examination that used the same or a similar imaging study; and/or a previous examination of a patient with the same or similar characteristics, such as, age, sex, symptoms/signs, etc., as the current patient. Other ways to configure the input module 102 to allow information regarding any number of previously analyzed images to be input may exist, as known to those skilled in the art.

In the system 100, the analysis module 104 is configured to select an image manipulating function(s) based on the image information. The analysis module 104 can be configured to select an image manipulating function(s) in many ways. For example, in certain embodiments, the analysis module 104 can be configured to select an image manipulating function(s) that is the same or similar to an image manipulating function(s): applied in a previous examination of the same patient; applied in a previous examination performed by the same specialist; applied in a previous examination that used the same or a similar imaging study; and/or applied in a previous examination of a patient with the same or similar characteristics, such as, age, sex, symptoms, etc., as the current patient. For example, in certain embodiments, the analysis module 104 can be configured to select an image manipulating function(s), such as a LUT, based on the type of procedure performed and the body part that is being analyzed. For example, in certain embodiments, the analysis module 104 can be configured to select a certain LUT(s) when a mammogram of a chest is performed and another LUT(s) when a scan of a head is performed. For example, in certain embodiments, the analysis module 104 can be configured to select an image manipulating function(s), such as a window level, based on the histogram of an image. For example, in certain embodiments, the analysis module 104 can be configured to select a window level based on the histogram of an image such that at the selected window level, the histogram of the image is neither too sharp, where the pixel values are concentrated around a certain value, or too flat, where the pixel values are spread out. Other ways to configure the analysis module 104 to select an image manipulating function(s) may exist, as known to those skilled in the art.

In the system 100, the storage module 106 is configured to store an image and a selected image manipulating function(s). For example, in certain embodiments, the storage module 106 can be configured to store an image and a selected image manipulating function(s) in: a database that is part of a RIS; a database that is part of a HIS; a database that is accessible via the Internet; a local database; and/or any database that is in networked communication with the storage module 106. Other ways to configure the storage module 106 to store an image and a selected image manipulating function(s) may exist, as known to those skilled in the art.

In the system 100, the storage module 106 can be configured to store an image in many ways. For example, in certain embodiments, the storage module 106 can be configured to store an image without cropping the image. For example, in certain embodiments, the storage module 106 can be configured to store an image after cropping the image. In such embodiments, the storage module 106 can be configured to store the cropped version of the image as well as the non-cropped version of the image or store the cropped version of the image in lieu of the non-cropped version of the image. Other ways to configure the storage module 106 to store images may exist, as known to those skilled in the art.

In the system 100, the storage module 106 can be configured to store many types of selected image manipulating functions. For example, in certain embodiments, the storage module 106 can be configured to store: the amount(s) an image could be enlarged, if any, what window/level(s) could be associated with an image, if any, what LUT(s) could be applied to an image, if any, and/or what filter(s) could be applied to an image, if any. Other ways to configure the storage module 106 to store other types of selected image manipulating function(s) may exist, as known to those skilled in the art.

In the system 100, the output module 108 is configured to output an image and a selected image manipulating function(s). The output module 108 can be configured to output an image in many ways. For example, the output module 108 can be configured to output an image as a visual display and/or printed matter. In one embodiment, the output module 108 can be configured to output an image as a visual display on a Picture Arching and Communicating System (PACS) workstation, for example. It may be desirable to configure the output module 108 to output an image in other ways, as known to those skilled in the art.

In the system 100, the output module 108 can be configured to output a selected image manipulating function(s) in many ways. For example, in an embodiment, the output module 108 can be configured to output a selected image manipulating function(s) as a visual display. In such an embodiment, the selected image manipulating function(s) can be made accessible via a pull-down menu and/or a context menu, such as a context menu that is displayed when an image is right-clicked, for example. In another embodiment, the output module 108 can be configured to output a selected image manipulating function(s) as printed matter. In such an embodiment, the selected image manipulating function(s) can be printed along with an image, for example. It may be desirable to configure the output module 108 to output a selected image manipulating function(s) in other ways, as known to those skilled in the art.

In certain embodiments, the output module 108 can be configured to apply a selected image manipulating function(s) to an image prior to outputting the image. For example, in an embodiment, the output module 108 can be configured to: crop an image, enlarge an image; select a window/level at which an image will be displayed; apply a LUT(s) to an image; and/or apply a filter(s) to an image before outputting the image. In such an embodiment, the output module 108 can be configured to apply the most preferred image manipulating function(s) of the selected image manipulating function(s). In such an embodiment, the output module 108 can be configured to output any remaining selected image manipulating function(s) that were not already applied.

In certain embodiments, the system 100 can be implemented such that an image and a selected image manipulating function(s) is stored by the storage module 106 prior to being output by the output module 104. In certain embodiments, the system 100 can be implemented such that an image and a selected image manipulating function(s) is output by the output module 104 without first being stored by the storage module 106.

The modules of the system 100 can be implemented in many ways. For example, the modules can be implemented in hardware and/or software. The modules can be implemented separately and/or integrated in various combinations. Other desirable ways to implement the modules of the system 100 may exist, as known to those skilled in the art.

The system 100 can also be implemented in many ways. For example, the system 100 can be integrated with existing applications that run on a Microsoft® platform and/or other platforms as an add-on product. In one implementation, the system 100 can be integrated with a workstation(s) that is connected to a HIS and/or a RIS, such as a PACS workstation, for example. Other desirable ways to implement the system 100 may exist, as known to those skilled in the art.

In operation, an embodiment of the system 100 can be implemented in connection with a HIS and/or a RIS, for example. In such an embodiment, the input module 102 can be configured to input an image from an imaging system, such as a CT, MR, CR and/or NM imaging system, for example. Information regarding the image that is input into the input module 102 can also be input to the input module 102. For example, information regarding the image that is input into the input module 102 can include: imaging study information, such as, what type of imaging study the image is a part of, what type of ailment the imaging study is devised to detect and/or what area of the body the imaging study is focused on; patient information, such as, the patient's identity, the patient's age, the patient's sex, whether the patient has previously undergone the same and/or a similar imaging study, and/or the patient's symptoms; and/or specialist information (for example, radiologist information), such as, the specialist's identity. Information regarding a previously analyzed image(s) can also be input to the input module 102. For example, information regarding a previously analyzed image(s) can include the same and/or similar information as that discussed in the previous sentence with regard to the image that is input into the input module 102, as well as image manipulation information, such as, what portion of the image, if any, was focused on by cropping the image, the amount the image was enlarged, if any, what window/level was associated with the image, if any, what LUT(s) was applied to the image, if any, and/or what filter(s) was applied to the image, if any. The analysis module 104 can then select an image manipulating function based on the image information. For example, the analysis module 104 can select an image manipulating function(s) that is the same or similar to the image manipulating function(s): applied in a previous examination of the same patient; applied in a previous examination performed by the same specialist; applied in a previous examination that used the same or a similar imaging study; and/or applied in a previous examination of a patient with the same or similar characteristics, such as, age, sex, symptoms, etc., as the current patient.

In one example, a patient that is undergoing an imaging study has previously undergone the same or a similar imaging study. In such an example, the input module 102 can input: images from the current imaging study; information regarding the current imaging study and the patient; and information regarding the patient's previous imaging study, such as, which image manipulating function(s) was applied during the previous imaging study. Then, the analysis module 104 can select an image manipulating function(s) that is the same or similar to the image manipulating function(s) applied in the patient's previous imaging study.

In another example, a patient that is undergoing an imaging study has not previously undergone the same or a similar imaging study, but the specialist that will be analyzing the images in the imaging study has previously analyzed images in the same or a similar imaging study. In such an example, the input module 102 can input: images from the current imaging study; information regarding the current imaging study and the specialist; and information regarding the specialist's previous imaging study, such as, which image manipulating function(s) was applied during the previous imaging study. Then, the analysis module 104 can select an image manipulating function(s) that is the same or similar to the image manipulating function(s) applied in the specialists previous imaging study.

In another example, a patient that is undergoing an imaging study has not previously undergone the same or a similar imaging study, and the specialist that will be analyzing the images in the imaging study has not previously analyzed images in the same or a similar imaging study, but another specialist has previously analyzed images in the same or a similar imaging study. In such an example, the input module 102 can input: images from the current imaging study; information regarding the current imaging study and the patient; and information regarding a previous imaging study that was analyzed by a specialist that is not the specialist that will be analyzing the images in the imaging study, such as, which image manipulating function(s) was applied during the previous imaging study. Then, the analysis module 104 can select an image manipulating function(s) that is the same or similar to the image manipulating function(s) applied in the previous imaging study that was analyzed by a specialist that is not the specialist that will be analyzing the images in the imaging study.

In operation of an embodiment of the system 100, once the analysis module 104 has selected an image manipulating function(s), the system 100 can store, via the storage module 106, and/or output, via the output module 108, the image and the image manipulating function(s).

In one example, if the analysis module 104 has selected an image manipulating function that is cropping a certain portion of the image, a new image that only includes the desired portion of the image can be created and stored in a database via the storage module 106 or the original un-cropped image and data indicating that the image could be cropped as indicated can be stored in a database via the storage module 106. Also, the image can be cropped as indicated and output via the output module 108, or the image can be output without being cropped and cropping the image as indicated can be output via the output module 108 as a preferred image manipulating function.

In another example, if the analysis module 104 has selected an image manipulating function that is enlarging the image by a certain amount, the image and data indicating that the image could be enlarged by that certain amount can be stored in a database via the storage module 106. Also, the image can be enlarged by that certain amount and output via the output module 108, or the image can be output without being enlarged and enlarging the image by that certain amount can be output via the output module 108 as a preferred image manipulating function.

In another example, if the analysis module 104 has selected an image manipulating function that is selecting a certain window/level, the image and data indicating that the image could be displayed using the selected window/level can be stored in a database via the storage module 106. Also, the image can be displayed at the selected window/level when it is output via the output module 108, or the image can be output without being displayed at the selected window/level and displaying the image at that certain window/level can be output via the output module 108 as a preferred image manipulating function.

In another example, if the analysis module 104 has selected an image manipulating function that is applying a LUT, the image and data indicating that the LUT could be applied to the image can be stored in a database via the storage module 106. Also, the LUT can be applied to the image and then the image can be output via the output module 108, or the image can be output without applying the LUT and applying the LUT to the image can be output via the output module 108 as a preferred image manipulating function.

In another example, if the analysis module 104 has selected an image manipulating function that is applying a filter, the image and data indicating that the filter could be applied to the image can be stored in a database via the storage module 106. Also, the filter can be applied to the image and then the image can be output via the output module 108, or the image can be output without applying the filter and applying the filter to the image can be output via the output module 108 as a preferred image manipulating function.

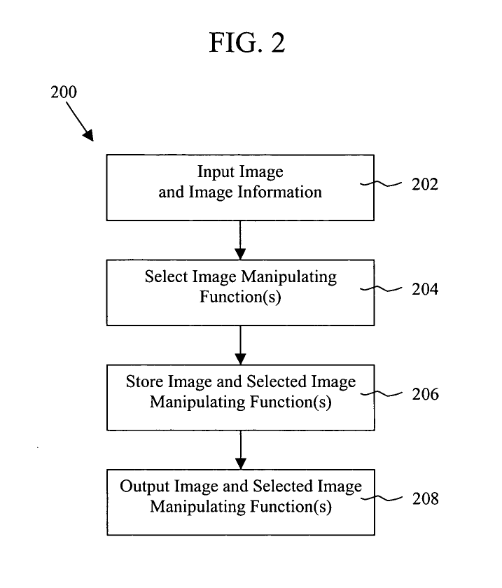

FIG. 2 illustrates a method for manipulating an image 200 used in accordance with an embodiment of the present invention. At 202, an image and image information is input. For example, an image can be input from an imaging system, image information regarding the input image can be input from an imaging system and/or a database and image information regarding a previously analyzed image can be input from a database. At 204, an image manipulating function(s) is selected. For example, based on the image information input at 202, an image manipulating function(s) can be selected. At 206, the image and selected image manipulating function(s) are stored. For example, the image input at 202 and the image manipulating function(s) selected at 204 can be stored in a database. At 208, the image and selected image manipulating function(s) are output. For example, the image and selected image manipulating function(s) can be output as visual display and/or printed matter.

Due to the various manners in which an image can be manipulated to provide enhanced viewing, figuring out which image manipulating function(s) to apply to an image to provide enhanced viewing and locating the selected image manipulating function(s) can be tedious and time consuming. Applying the method 200, as described above and/or in light of the description of FIG. 1, may provide improved and/or streamlined selection of image manipulating functions.

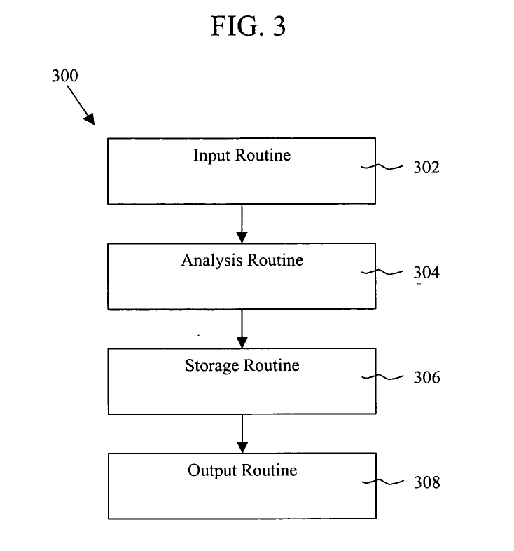

FIG. 3 illustrates a set of computer instructions for manipulating an image 300 used in accordance with an embodiment of the present invention. The set of computer instructions 300 in FIG. 3 includes an input routine 302, which allows an image and image information to be input; an analysis routine 304, which allows an image manipulating function to be selected based on the image information; a storage routine 306, which allows the image and the selected image manipulating function(s) to be stored; and an output routine 308, which allows the image and the selected image manipulating function(s) to be output.

In certain embodiments, the input routine 302, the analysis routine 304, the storage routine 306, and the output routine 308 may be implemented and/or may perform functions similar to the input module 102, the analysis module 104, the storage module 106 and the output module 108, respectively, as described above in relation to FIG. 1.

While the invention has been described with reference to embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An image manipulation system used in a medical examination comprising:
an input module configured to input an image and image information; and
an analysis module configured to select an image manipulating function based on the image information.

2. The system of claim 1, wherein image information includes an imaging procedure and a body part that is the focus of the imaging procedure, and the image manipulating function is a lookup table.

3. The system of claim 1, wherein image information includes a histogram of the input image and the image manipulating function is a window level.

4. The system of claim 1, wherein image information includes information regarding an input image and information regarding manipulation of a previously examined image.

5. The system of claim 4, wherein the previously examined image was manipulated by at least one of cropping, enlarging, selecting a window/level, applying a lookup table and applying a filter, and wherein the selected image manipulating function is at least one of cropping, enlarging, selecting a window/level, applying a lookup table and applying a filter.

6. The system of claim 1, further comprising an output module, wherein the output module is configured to output the image, and wherein the output module is configured to apply the selected image manipulating function to the image prior to outputting the image.

7. The system of claim 1, further comprising an output module, wherein the output module is configured to output the image and the selected image manipulating function to a Picture Arching and Communicating System workstation.

8. A method for manipulating an image used in a medical examination comprising:
inputting an image and image information; and
selecting an image manipulating function based on the image information.

9. The method of claim 8, wherein image information includes an imaging procedure and a body part that is the focus of the imaging procedure, and the image manipulating function is a lookup table.

10. The method of claim 8, wherein image information includes a histogram of the input image and the image manipulating function is a window level.

11. The method of claim 8, wherein image information includes information regarding an input image and information regarding manipulation of a previously examined image.

12. The method of claim 11, wherein the previously examined image was manipulated by at least one of cropping, enlarging, selecting a window/level, applying a lookup table and applying a filter, and wherein the selected image manipulating function is at least one of cropping, enlarging, selecting a window/level, applying a lookup table and applying a filter.

13. The method of claim 8, further comprising:
applying the selected image manipulating function to the image; and
outputting the image.

14. The method of claim 8, further comprising outputting the image and the selected image manipulating function to a Picture Arching and Communicating System workstation.

15. A computer-readable storage medium including a set of computer instructions for manipulating an image used in a medical examination, the set of instructions comprising:
an input routine that allows an image and image information to be input; and
an analysis routine that allows an image manipulating function to be selected based on the image information.

16. The set of instructions of claim 15, wherein image information includes an imaging procedure and a body part that is the focus of the imaging procedure, and the image manipulating function is a lookup table.

17. The set of instructions of claim 15, wherein image information includes a histogram of the input image and the image manipulating function is a window level.

18. The set of instructions of claim 15, wherein image information includes information regarding an input image and information regarding manipulation of a previously examined image.

19. The set of instructions of claim 18, wherein the previously examined image was manipulated by at least one of cropping, enlarging, selecting a window/level, applying a lookup table and applying a filter, and wherein the selected image manipulating function is at least one of cropping, enlarging, selecting a window/level, applying a lookup table and applying a filter.

20. The set of instructions of claim 15, further comprising an output routine, wherein the output routine allows the image to be output, and wherein the output routine allows the selected image manipulating function to be applied to the image prior to allowing the image to be output.

21. The set of instructions of claim 15, further comprising an output routine, wherein the output routine allows the image and the selected image manipulating function to be output to a Picture Arching and Communicating System workstation.
